(19) United States
(12) Patent Application Publication
(10) Pub. No.: US 2019/0304433 A1
(43) Pub. Date: Oct. 3, 2019

(54) ELASTIC STRUCTURE BETWEEN TWO OBJECTS

(71) Applicant: CONCRAFT HOLDING CO., LTD., New Taipei City (TW)

(72) Inventors: Zheng-Xiang WANG, Kunshan City (CN); Chih-Ming SHEN, New Taipei City (TW); Heng YANG, Kunshan City (CN)

(21) Appl. No.: 16/031,241

(22) Filed: Jul. 10, 2018

(30) Foreign Application Priority Data
Mar. 30, 2018 (TW) 107111254

(51) Int. Cl. G10K 13/00

(52) U.S. Cl. CPC G10K 13/00; H04R 2499/11

(57) ABSTRACT

An elastic structure between two objects, consisting of a first object provided with at least one first side, a second object provided with at least one second side, and an elastic connecting object that is connected between the first object and the second object, wherein the first side and the second side mutually correspond. The elastic connecting object is provided with a first connecting portion that connects to the first side, a second connecting portion that connects to the second side, and an elastic connecting portion that connects between the first connecting portion and the second connecting portion. Accordingly, the elastic connecting portion is provided with an elastic restoring force, which enables the second connecting portion and the first connecting portion to realize an elastic displacement function that enables achieving mutually relative up/down elastic displacement positions between the first object and the second object.

### BACKGROUND OF THE INVENTION

### (a) Field of the Invention

The present invention relates to an elastic structure between two objects, and more particularly to an elastic structure able to provide an up/down elastic displacement function between two objects, and which has application in acoustic diaphragms or notebook computer touch screens.

### (b) Description of the Prior Art

For the purpose of convenient portability, there is the gradual development trend towards greater thinness in current mobile devices, such as smart cell phones or tablet computers. And in order to achieve the requirements for thinness of mobile devices, it is necessary to reduce the size and thickness of each of the components within the mobile device to enable containing the components therein and satisfy the requirement for the thinning tendency.

Furthermore, apart from the requirement to satisfy the thinning tendency of mobile devices, there is also the requirement for very high quality sound. Accordingly, with the thinning tendency of mobile devices, providing the mobile device with a miniaturized speaker able to present high quality sound is a huge challenge for current mobile devices.

For example, U.S. Pat. No. 9,820,066 provides a micro speaker, comprising a diaphragm and a voice coil that drives and vibrates the diaphragm to produce sound. The diaphragm comprises a conductive dome and a suspension surrounding the conductive dome. The micro speaker further comprises a conductive front cover positioned on the conductive dome, and a capacitor structure is formed between the conductive front cover and the conductive dome. When the diaphragm vibrates, the electrical signal output by the capacitor structure causes an instantaneous feedback that effects a vibration displacement of the diaphragm, thus providing a technical disclosure able to realize instantaneous and accurate feedback that effects vibration displacement of a diaphragm.

However, during manufacture, after separately forming the aforementioned diaphragm and conductive dome, the conductive dome is then adhered to the diaphragm. In other words, only a single adhesive surface is used between the conductive dome and the diaphragm, hence, continuous mutual pulling at the adhesive area between the conductive dome and the diaphragm results when the diaphragm produces a vibration displacement. And when the adhesive bond is no longer reliable, then separation between the conductive dome and the diaphragm easily occurs, further shortening the serviceable life of the entire micro speaker.

Accordingly, the objectives of the present invention involves resolving the technical problems that enable increasing the adhesivity between the conductive dome and the diaphragm while concurrently maintaining the elasticity between the conductive dome and the diaphragm.

### SUMMARY OF THE INVENTION

The main object of the present invention lies in providing an elastic structure between two objects, and more particularly to an elastic structure able to provide an up/down elastic displacement function between two objects, and which has application in acoustic diaphragms or notebook computer touch screens.

In order to achieve the aforementioned object, the present invention provides an elastic structure between two objects, comprising a first object, a second object, and at least one elastic connecting object, wherein the first object is provided with at least one first side, and the second object, separated from the first object, is provided with at least one second side corresponding and neighboring the first side. The elastic connecting object is connected between the first object and the second object, and is provided with a first connecting portion that connects to the first side, a second connecting portion that connects to the second side, and an elastic connecting portion that connects between the first connecting portion and the second connecting portion. In addition, the first connecting portion is provided with a first assembly portion used to enable the first side to embed therein, and the second connecting portion is provided with a second assembly portion used to enable the second side to embed therein. The elastic connecting portion is thus provided with elastic restoring force, effecting an elastic displacement function between the second connecting portion and the first connecting portion. When the first object is connected to the first connecting portion and the second object is connected to the second connecting portion, mutually relative up/down elastic displacement positions are provided between the first object and the second object using the elastic displacement function.

In one embodiment, the first object is manufactured from metallic material, the second object is manufactured from plastic material, and the elastic connecting object is manufactured from elastic material.

In the embodiment, the elastic material is silicone.

In the embodiment, the first assembly portion comprises a first side wall, a first upper wall that extends from the upper end of the first side wall, and a first lower wall that extends from the lower end of the first side wall and corresponds to the first upper wall. In addition, the first side wall, the first upper wall, and the first lower wall structurally form a groove.

In the embodiment, the second assembly portion comprises a second side wall, a second upper wall that extends from the upper end of the second side wall, and a second lower wall that extends from the lower end of the second side wall and corresponds to the second upper wall. In addition, the second side wall, second upper wall, and the second lower wall structurally form a groove.

In the embodiment, the elastic connecting portion assumes an arc shape.

In an embodiment, the first object and the second object are both manufactured from metallic material, and the elastic connecting object is manufactured from elastic material.

In the embodiment, the elastic material is silicone.

In an embodiment, the first object is a plate, and the first sides are circumferentially positioned on the peripheral edges of the plate. The second object is a frame, and the second sides are circumferentially positioned on the peripheral edges of the frame and correspond to the first sides.

In an embodiment, the first object is a plate, and the second object further comprises a first panel and a second panel corresponding to the first panel, wherein the first object is positioned between the first panel and the second panel. The first object is formed with first sides respectively corresponding to the neighboring end edges of the first panel and the second panel, moreover, the first panel and the second panel are respectively formed with a second side. In addition, the elastic connecting object is disposed between the first object and the first panel and between the first object and the second panel.

The elastic structure between two objects of the present invention has the following advantages compared to the prior art:

The present embodiment uses the functional embedded assembly effect of the first side of the first object and the second side of the second object in the first connecting portion and the second connecting portion of the elastic connecting object, respectively, to achieve preventing the first object and the second object from separating when effecting up/down elastic displacement positions through the elastic connecting portion.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a three-dimensional view of a first embodiment of the present invention.

FIG. 2 is an exploded three-dimensional view of the first embodiment of the present invention.

FIG. 3 is a cross-sectional view of the first embodiment of the present invention.

FIG. 4 is a three-dimensional view of a second embodiment of the present invention.

FIG. 5 is a cross-sectional view of the second embodiment of the present invention.

FIG. 6 is an exploded three-dimensional view of a third embodiment of the present invention.

FIG. 7 is a cross-sectional view of the third embodiment applied in a micro speaker according to the present invention.

### DETAILED DESCRIPTION OF THE PREFERRED EMBODIMENTS

Regarding the detailed content and structural means of the present invention, please refer to the description of the diagrams as follows:

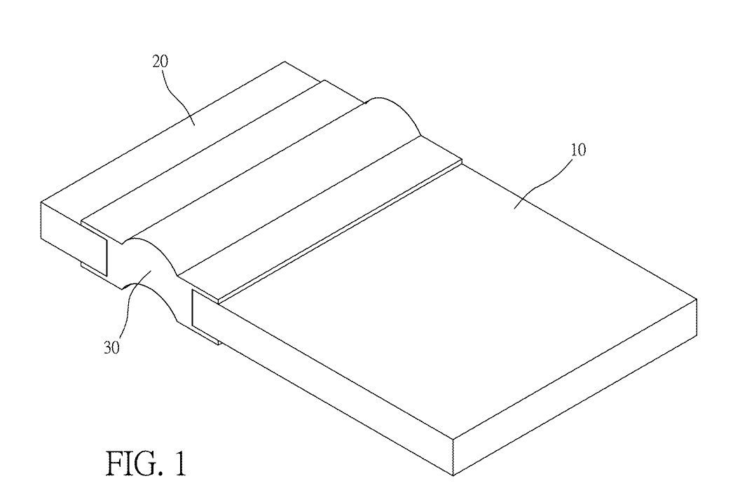

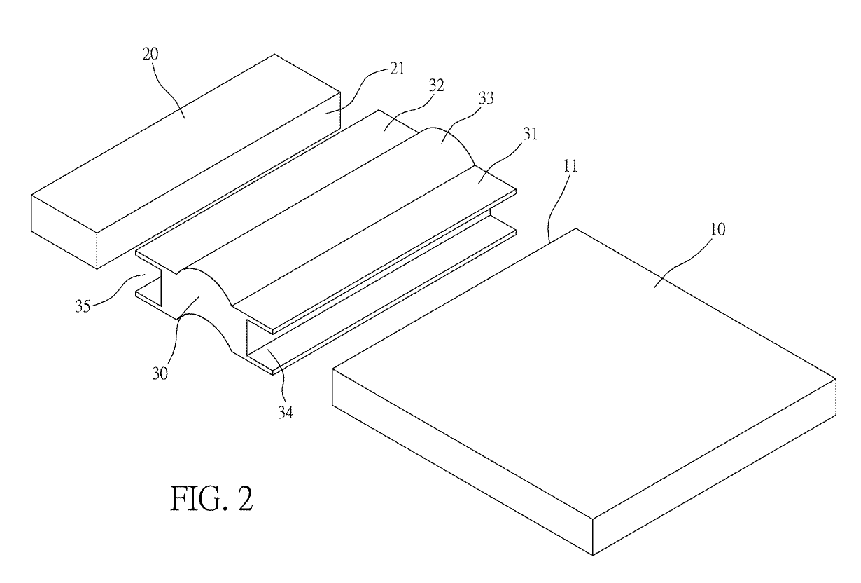

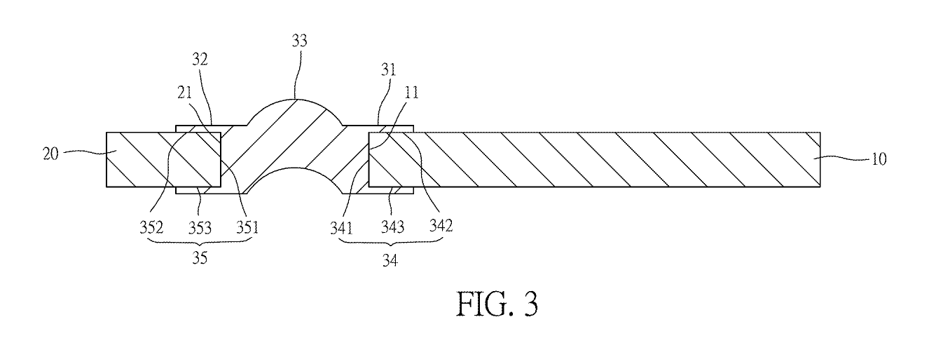

As shown in FIGS. 1 to 3, which show a first embodiment of an elastic structure between two objects of the present invention, wherein a structural configuration comprises a first object 10, a second object 20, and at least one elastic connecting object 30, wherein the first object 10 is manufactured from metallic material, the second object 20 is manufactured from plastic material, and the elastic connecting object 30 is manufactured from elastic material.

Specifically, the first object 10 is provided with at least one first side 11, and the second object 20, separated from the first object 10, is provided with at least one second side 21 corresponding and neighboring the first side 11. The elastic connecting object 30 is connected between the first object 10 and the second object 20, and is provided with a first connecting portion 31 that connects to the first side 11, a second connecting portion 32 that connects to the second side 21, and an elastic connecting portion 33 that connects between the first connecting portion 31 and the second connecting portion 32. In addition, the first connecting portion 31 is provided with a first assembly portion 34 used to enable the first side 11 to embed therein, and the second connecting portion 32 is provided with a second assembly portion 35 used to enable the second side 21 to embed therein. The elastic connecting portion 33 is thus provided with elastic restoring force. In the present embodiment, the first assembly portion 34 is provided with a first side wall 341, a first upper wall 342 that extends from the upper end of the first side wall 341, and a first lower wall 343 that extends from the lower end of the first side wall 341 and corresponds to the first upper wall 342. Furthermore, the first side wall 341, the first upper wall 342, and the first lower wall 343 structurally form a groove. The second assembly portion 35 is provided with a second side wall 351, a second upper wall 352 that extends from the upper end of the second side wall 351, and a second lower wall 353 that extends from the lower end of the second side wall 351 and corresponds to the second upper wall 352. Furthermore, the second side wall 351, the second upper wall 352, and the second lower wall 353 structurally form a groove. The grooves respectively formed by the first connecting portion 31 and the second connecting portion 32 are respectively orientated in opposite directions.

When the first object 10 is embedded within the first assembly portion 34 using the first side 11, the first upper wall 342 is positioned on the upper end of the first object 10 and tightly fitted on the upper end surface thereof. The first lower wall 343 is thus positioned on the lower end of the first object 10 and tightly fitted on the lower end surface thereof. Moreover, the side edge of the first side 11 is tightly fitted against the first side wall 341. When the second object 20 is embedded within the second assembly portion 35 using the second side 21, the second upper wall 352 is positioned on the upper end of the second object 20 and tightly fitted on the upper end surface thereof. The second lower wall 353 is thus positioned on the lower end of the second object 20 and tightly fitted on the lower end surface thereof. Moreover, the side edge of the second side 21 is tightly fitted against the second side wall 351. Accordingly, at least a tri-surface fitting effect is respectively formed between the first side 11 and the first assembly portion 34 and also between the second side 21 and the second assembly portion 35, which further effectively increases the surface fitting area and augments the joining force therebetween.

Furthermore, in the present embodiment, the elastic connecting object 30 is manufactured from elastic material, such as silicone, rubber, or, other material having elastic properties. Hence, because the elastic connecting object 30 is manufactured from elastic material, thus, the elastic connecting portion 33 is provided with an elastic restoring force. Moreover, because the elastic connecting portion 33 assumes an arc-shaped form between the first connecting portion 31 and the second connecting portion 32, thus, the first connecting portion 31 and the second connecting portion 32 are able to use the elastic connecting portion 33 to effect an elastic displacement function. Accordingly, when the first object 10 and the second object 20 are respectively disposed in the first connecting portion 31 and the second connecting portion 32 of the elastic connecting object 30, mutually relative up/down elastic displacement positions are provided between the first object 10 and the second object 20 through the elastic displacement function therebetween.

Accordingly, the present embodiment uses the functional embedded assembly effect of the first side 11 of the first object 10 and the second side 21 of the second object 20 in the first connecting portion 31 and the second connecting portion 32 of the elastic connecting object 30, respectively, to achieve preventing the first object 10 and the second object 20 from separating when effecting up/down elastic displacement positions through the elastic connecting portion 33.

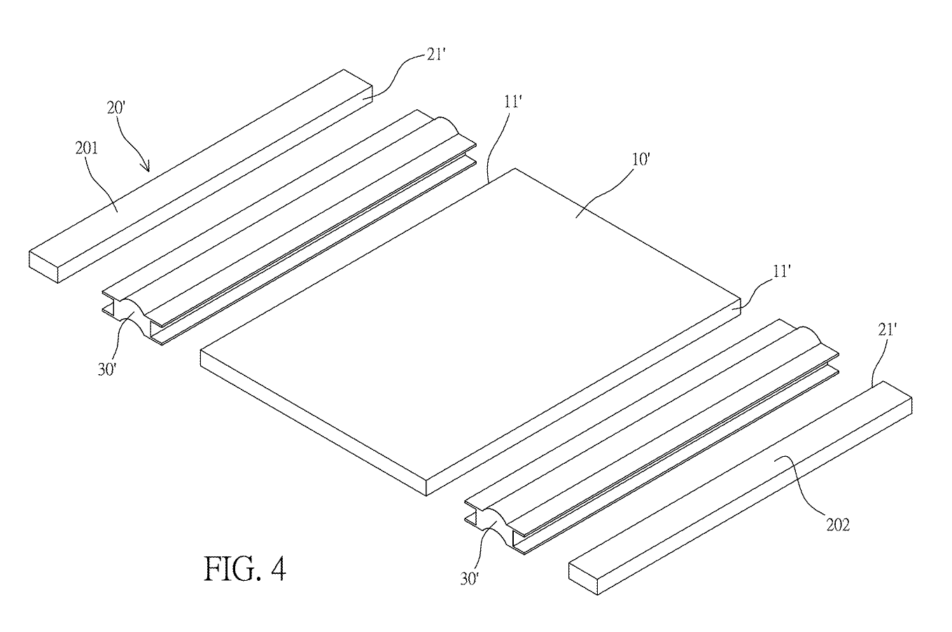

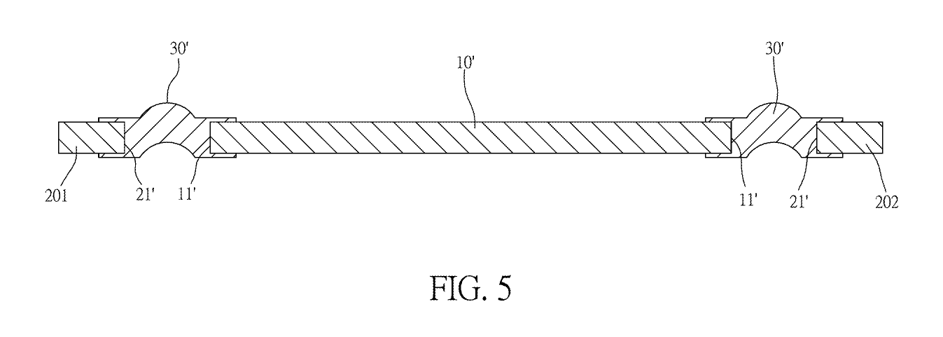

Referring to FIGS. 4 and 5, which show a second embodiment of the present invention, wherein a first object 10′ is a plate manufactured from metallic material, and second objects 20′ manufactured from metallic material respectively comprise a first panel 201 and a second panel 202 corresponding to the first panel 201. The first object 10′ is positioned between the first panel 201 and the second panel 202, thereby effecting a separation therebetween, moreover, the first object 10′ is formed with first sides 11′ respectively corresponding to the neighboring end edges of the first panel 201 and the second panel 202. The end edges of the first panel 201 and the second panel 202 corresponding to the neighboring first sides 11′ of the first object 10′ are respectively formed with a second side 21′. An elastic connecting object 30′ is disposed between the first object 10′ and the first panel 201 and between the first object 10′ and the second panel 202, further enabling the first object 10′ to use the elastic connecting objects 30′ thereby configured to effect up/down elastic displacements relative to the first panel 201 and the second panel 202.

Furthermore, the second embodiment of the present embodiment has application in a touch screen of notebook computers (not shown in the drawings), whereby when the first panel 201 and the second panel 202 are respectively fixed to the notebook computer, the first object 10′ is able to be positioned at the location of the touch screen, thereby enabling producing up/down elastic displacement between the first panel 201 and the second panel 202 using the first object 10′ to achieve a touch key effect.

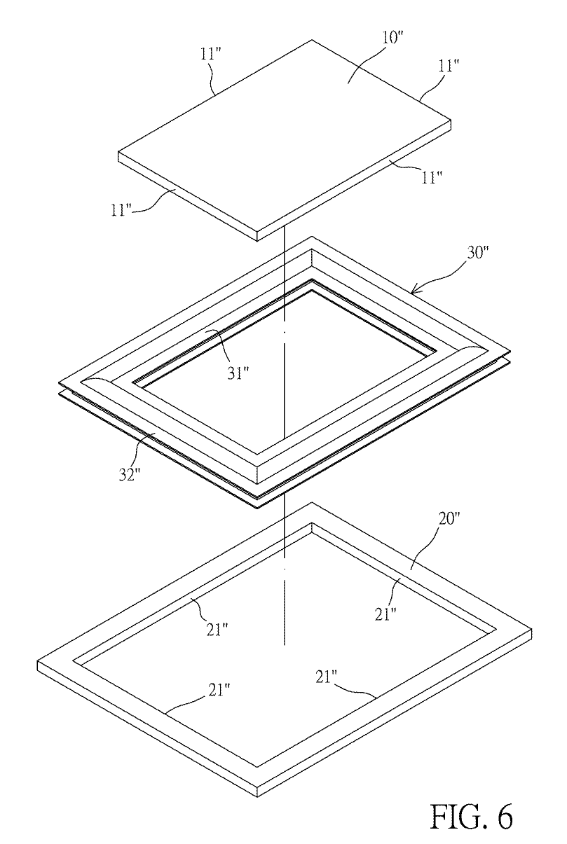

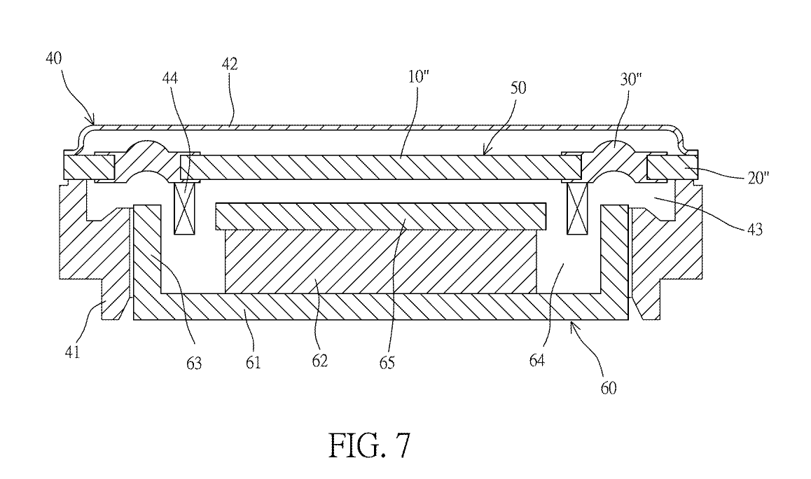

Further referring to FIGS. 6 and 7, which show a third embodiment of the present invention, wherein a first object 10″ is a plate, and a second object 20″ is a frame that is circumferentially positioned on and separated from the periphery of the first object 10″. In addition, first sides 11″ are circumferentially provided on the peripheral edges of the plate-shaped first object 10″, and second sides 21″ are circumferentially provided on the inner edges of the frame-shaped second object 20″ corresponding to the first sides 11″. An elastic connecting object 30″ assumes a circumferential form similar to the second object 20″ that enables the first object 10″ to circumferentially join thereto using a first connecting portion 31″ as well as to circumferentially join to the second object 20″ using second connecting portions 32″. Moreover, in the third embodiment, the first object 10″ is manufactured from metallic material, and the second object 20″ is manufactured from plastic material.

The third embodiment of the present embodiment has application in the interior of a micro speaker 40, whereby the first object 10″, the second object 20″, and the elastic connecting object 30″ are assembled to form a diaphragm 50. The diaphragm 50 is disposed on a speaker stand 41 of the micro speaker 40 and within a retaining space 43 formed by a conductive cover plate 42. In addition, a voice coil 44 used to drive and vibrate the diaphragm 50 is disposed on the diaphragm 50, wherein the voice coil 44 is disposed on the bottom portion of the first connecting portion 31″ of the elastic connecting object 30″. Moreover, the interior of the retaining space 43 further contains a magnetic circuit system 60, which comprises a lower clamp plate 61, a first magnet portion 62 disposed on the lower clamp plate 61, and a second magnet portion 63. At least one of the first magnet portion 62 and the second magnet portion 63 is a permanent-magnet. The second magnet portion 63 surrounds the configuration of the first magnet portion 62 forming a magnetic space 64 therebetween. The voice coil 44 is disposed within the magnetic space 64, with the magnetic circuit system 60 further comprising a pole piece 65 attached to the first magnet portion 62.

Accordingly, when using the diaphragm 50 assembled from the first object 10″, the second object 20″, and the elastic connecting object 30″, the voice coil 44 is used to drive and vibrate the diaphragm 50, whereupon an up/down elastic displacement of the first object 10″ is produced between the second object 20″ through the elastic connecting object 30″. And because of the embedded assembly function of the first side 11″ of the first object 10″ and the second side 21″ of the second object 20″ with the first connecting portion 31″ and the second connecting portion 32″ of the elastic connecting object 30″, respectively, the first object 10″ and the second object 20″ are prevented from separating using the up/down elastic displacement effect of the elastic connecting object 30″ produced by the vibrating diaphragm 50. Accordingly, the third embodiment of the present invention is able to substantially increase the serviceable life of the micro speaker 40 while effecting an instantaneous feedback vibration displacement.

In conclusion, the present invention clearly complies with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An elastic structure between two objects, comprising:
a first object, which is provided with at least one first side;
a second object, which is separated from the first object, and is provided with at least one second side corresponding to the first side; and
at least one elastic connecting object, which is connected between the first object and the second object, and is provided with a first connecting portion that connects to the first side, a second connecting portion that connects to the second side, and an elastic connecting portion that connects between the first connecting portion and the second connecting portion, the first connecting portion is provided with a first assembly portion used to enable the first side to embed therein, and the second connecting portion is provided with a second assembly portion used to enable the second side to embed therein, the elastic connecting portion is thus provided with elastic restoring force effecting an elastic displacement function between the second connecting portion and the first connecting portion; when the first object is connected to the first connecting portion and the second object is connected to the second connecting portion, mutually relative up or down elastic displacement positions are provided between the first object and the second object using the elastic displacement function.

2. The elastic structure between two objects according to claim 1, wherein the first object is manufactured from metallic material, the second object is manufactured from plastic material, and the elastic connecting object is manufactured from elastic material.

3. The elastic structure between two objects according to claim 2, wherein the elastic material is silicone.

4. The elastic structure between two objects according to claim 1, wherein the first assembly portion is provided with a first side wall, a first upper wall that extends from the upper end of the first side wall, and a first lower wall that extends from the lower end of the first side wall and corresponds to the first upper wall, moreover, the first side wall, the first upper wall, and the first lower wall structurally form a groove.

5. The elastic structure between two objects according to claim 1, wherein the second assembly portion is provided with a second side wall, a second upper wall that extends from the upper end of the second side wall, and a second lower wall that extends from the lower end of the second side wall and corresponds to the second upper wall, moreover, the second side wall, the second upper wall, and the second lower wall structurally form a groove.

6. The elastic structure between two objects according to claim 2, wherein the elastic connecting portion assumes an arc shape.

7. The elastic structure between two objects according to claim 1, wherein the first object and the second object are both manufactured from metallic material, and the elastic connecting object is manufactured from elastic material.

8. The elastic structure between two objects according to claim 7, wherein the elastic material is silicone.

9. The elastic structure between two objects according to claim 1, wherein the first object is a plate, and the first sides are circumferentially positioned on the peripheral edges of the plate; the second object is a frame, and the second sides are circumferentially positioned on the peripheral edges of the frame.

10. The elastic structure between two objects according to claim 1, wherein the first object is a plate, and the second object further comprises a first panel and a second panel corresponding to the first panel, the first object is disposed between the first panel and the second panel, the first object is formed with first sides respectively corresponding to the neighboring end edges of the first panel and the second panel, moreover, the first panel and the second panel are respectively formed with a second side; an elastic connecting object is disposed between the first object and the first panel and between the first object and the second panel.
